(19) United States
(12) Patent Application Publication
(10) Pub. No.: US 2015/0271467 A1
(43) Pub. Date: Sep. 24, 2015

(54) CAPTURE OF THREE-DIMENSIONAL IMAGES USING A SINGLE-VIEW CAMERA

(71) Applicant: Neal Weinstock, Brooklyn, NY (US)

(72) Inventor: Neal Weinstock, Brooklyn, NY (US)

(21) Appl. No.: 14/220,248

(22) Filed: Mar. 20, 2014

(51) Int. Cl. H04N 13/02; H04N 5/235

(52) U.S. Cl. CPC H04N 13/0207; H04N 5/2353

(57) ABSTRACT

A single-lens camera captures a two-dimensional image and, nearly contemporaneously, manipulates focus of the camera to provide information regarding the distance from the camera of objects shown in the image. With this distance information, the camera synthesizes multiple views of the image to produce a three-dimensional view of the image. The camera can select a number of points of interest and engage an autofocus function to determine a focal length for which the point of interest is in particularly good focus or can capture a number of additional images at various focal lengths and identify portions of the additional images that are in relatively sharp focus. The distance estimates can be improved by identifying elements in the original image that are co-located with electronic beacons whose relative locations are known to the camera.

### FIELD OF THE INVENTION

The present invention relates generally to image capture systems, and, more particularly, to an image capture system that captures three-dimensional images using a single-view camera.

### BACKGROUND OF THE INVENTION

The ability to display images perceived as three-dimensional by human viewers has been with us for nearly 200 years, nearly as long as photography itself. Yet, nearly all cameras in circulation are incapable of capturing a three-dimensional image. Three-dimensional images are typically captured by specially crafted cameras, or pairs of cameras, capable of capturing two side-by-side images simultaneous.

There have been a number of attempts to adapt conventional two-dimensional cameras (i.e., cameras that capture two-dimensional images) such that they can also capture three-dimensional images. Many image-splitting adapters that fit on standard lens filter mountings are available, as are split lenses (i.e. systems with two lenses fitted into a single mount and barrel). These systems or devices result in two images taken from perspectives that are horizontally offset from one another, to be captured either on a single frame of the image-capture mechanism of the two-dimensional camera, e.g., film or a CCD, or on two separate image-capture mechanisms.

These adapters rarely produce good results. If the adapter is out of perfect rotational alignment with the camera, which is difficult to avoid since the lens filter mounting is circular, it is difficult, or even physically painful, for a human viewer to perceive the skewed images as a single three-dimensional image.

In addition, by far the most popular cameras in circulation today are the cameras embedded in mobile telephones. There is no standard lens filter/adapter mount on mobile telephones. In fact, most—if not all—mobile telephones have no lens filter/adapter mounts at all. Given the tiny size of the lenses in these devices and their complex optical design and mounting systems within the camera, adding accurate, distortion-free, and light-efficient stereo lens adapters to these devices is not a simple or inexpensive undertaking

Some attempts at three-dimensional photography using a two-dimensional camera without adaptation have been made. These attempts involve taking two or more photographs in quick succession, or a video sequence, from two or more positions that are horizontally offset from one another. If the camera is rotated or tilted even slightly during movement from one position to the other or if the subject matter to be photographed moves during movement from one position to the other, it is nearly impossible for a human viewer to perceive the two images as a single three-dimensional image. Digital image processing holds promise of correcting these flaws, but at cost of significantly greater computer power than may be available in even professional camera devices.

Another shortcoming of conventional attempts at three-dimensional photography is that most solutions produce exactly two views—one for the left eye of the viewer and one for the right eye. Autostereoscopic three-dimensional displays typically require more than just two views. High-quality, large-screen autostereoscopic displays require many more than two views—often 20, 30, or more views.

What is needed is a way to capture three-dimensional images using a conventional two-dimensional camera and in a way that does not limit the three-dimensional image to only two views.

### SUMMARY OF THE INVENTION

In accordance with the present invention, a single-lens camera captures a two-dimensional image and, nearly contemporaneously, manipulates focus of the camera to provide information regarding the distance from the camera of objects shown in the image. With this distance information, the camera—or other computing device—synthesizes multiple views of the image to produce a three-dimensional view of the image.

By synthesizing views from a single captured image, the alignment between the views can be carefully controlled to provide high quality three-dimensional views of the image. In addition, obviating special adapters for capture of multiple views of a three-dimensional image allows people to quickly and spontaneously capture three-dimensional views using a single, single-lens camera.

As used here, a “single-lens” camera does not mean that only a single optical element is positioned between subject matter to be photographed and the image capture medium. Instead, “single-lens” camera means that the camera captures only a single view of the subject through a single lens assembly, which can be a compound lens. Nearly all cameras in use today are considered “single-lens” cameras as the term is used herein.

There are a number of ways the camera can manipulate focus to estimate distances to a number of elements in the captured image. For example, the camera can select a number of points of interest and engage an autofocus function to determined a focal length for which the point of interest is in particularly good focus. Alternatively, the camera can capture a number of additional images at various focal lengths and identify portions of the additional images that are in relatively sharp focus. Both techniques provide a focal length at which elements of the original image are in relatively sharp focus. These focal lengths are converted to respective distance estimates for the various element of the original image and the distance estimates are converted to respective depths in a three-dimensional image.

The distance estimates can be improved by identifying elements in the original image that are co-located with electronic beacons whose relative locations are known to the camera, or by identifying elements in the original image that are co-located with objects whose distance from the camera and each other has been measured by electronic sensors, either located in the camera or in networked devices.

Once depths in a three-dimensional image have been determined for the various element of the original image, multiple views from respective perspectives can be synthesized by shifting the elements left or right in accordance with the respective depths.

This shifting of elements can result in the revelation of background elements, or parts of elements, that are occluded by foreground elements in any single view. In addition to conventional techniques for filling in revealed occlusions, the camera can use image data from other images that contain elements of the original image and can use object primitives to more accurately fill in revealed occlusions.

Other images that contain elements of the original image can be images captured during manipulation of focus of the camera for distance estimation. Alternatively, these other images that contain elements of the original image can be other images captured by the same camera while positioned at the same location, or at a nearby but deliberately different location, pointed at the same subject matter, and near in time. As an example of the latter, the photographer may decide to take a few pictures of the same scene within a few seconds of each other. These photographs can be used to provide missing image data for filling in of revealed occlusions.

A number of object primitives define general shapes of known types of things and some characteristics of these known types of things. For example, an object primitive representing a person can approximate a person's head, torso, and limbs with respective, interconnected cylinders and can specify that the appearance of a person can be approximated by assuming symmetry across a vertical axis, e.g., that a person's left arm can be approximated using a mirror-image of the person's right arm. By recognizing elements of the original image as matching the person object primitive, the camera can fill in portions of revealed occlusions corresponding to the person in a way that preserves the generally appearance of the person as that of a person.

### A BRIEF DESCRIPTION OF THE DRAWINGS

FIG. 1 is a diagram illustrating a camera that generates three-dimensional views of images captured through a single lens in accordance with the present invention.

FIG. 2 shows left and right views that collectively provide a three-dimensional view of the image of FIG. 1.

FIG. 3 is a logic flow diagram illustrating the generation of three-dimensional views of a two-dimensional image captured by the camera of FIG. 1 in accordance with the present invention.

FIGS. 4-7 are each a logic flow diagram showing a respective step of the logic flow diagram of FIG. 3 in greater detail.

FIG. 8 is a block diagram showing the camera of FIG. 1 in greater detail.

FIG. 9 shows a spherical graphical primitive used by the camera of FIG. 1 to fill in revealed occlusions when generating three-dimensional views of two-dimensional images in accordance with the present invention.

FIG. 10 shows a tree graphical primitive used by the camera of FIG. 1 to fill in revealed occlusions when generating three-dimensional views of two-dimensional images in accordance with the present invention.

FIG. 11 shows a human graphical primitive used by the camera of FIG. 1 to fill in revealed occlusions when generating three-dimensional views of two-dimensional images in accordance with the present invention.

FIG. 12 is a logic flow diagram illustrating the use by the camera of FIG. 1 of electronic beacons to improve distance estimation for objects photographed by the camera of FIG. 1.

FIG. 13 is a block diagram of a multi-layer depth map image used by the camera of FIG. 1 to generate three-dimensional views of two-dimensional images in accordance with the present invention.

FIG. 14 is a graphical representation of a depth map used by the camera of FIG. 1 to generate three-dimensional views of two-dimensional images in accordance with the present invention.

### DETAILED DESCRIPTION OF THE INVENTION

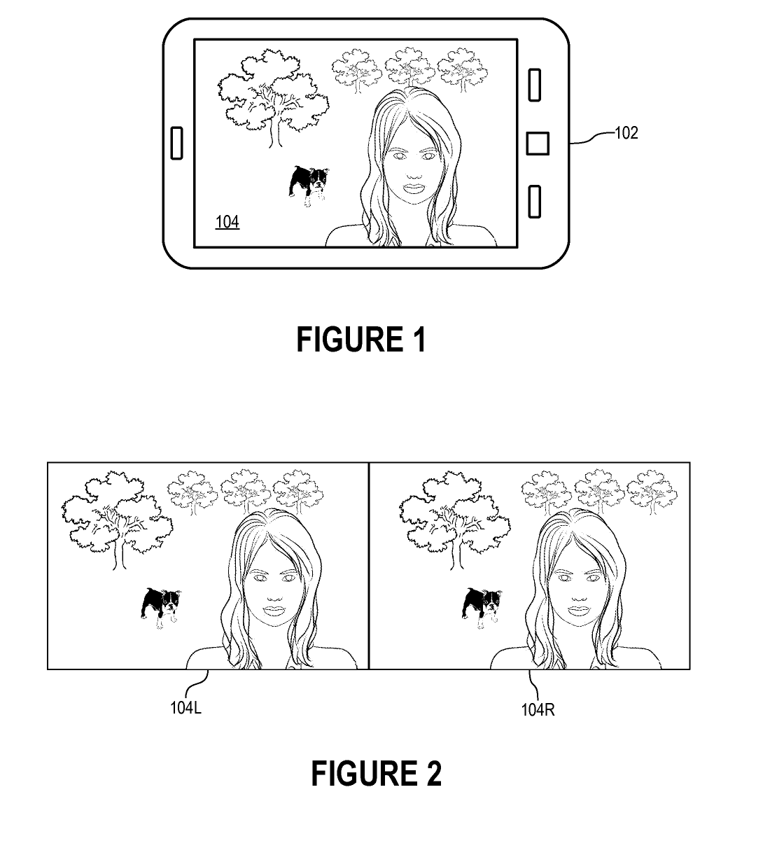

In accordance with the present invention, a camera 102 (FIG. 1) captures a two-dimensional image 104 and, while camera 102 continues to point at the subject matter of image 104, manipulates focus of camera 102 to provide information regarding the distance from camera 102 of objects shown in image 104. In a manner described more completely below, camera 102 uses the distance information to produce a depth map of image 104 and uses the depth map to produce at least two views 104L and 104R (FIG. 2) of image 104 to thereby provide a three-dimensional version of image 104.

To ensure that camera 102 continues to point at the subject matter of image 104 while manipulating focus to determine distances of objects in image 104, camera 102 manipulates focus to gather distance information as quickly as possible after capturing image 104. The varying of focus settings nearly contemporaneously with capture of image 104 allows logic within camera 102 to determine respective distances of elements shown in image 104. For example, determining a focal length at which a given element of image 104 is in best focus provides an estimate of the distance of the element from camera 102 when image 104 is captured. Similarly, causing camera 102 to autofocus on a given element of image 104 also provides a good focal length, and therefore an estimated distance from camera 102, for that element.

Once the respective distances from camera 102 of elements shown in image 104 are known, camera 102 maps those distances to depths within a three-dimensional version of image 104 to produce a depth map and uses the depth map to produce multiple views of image 104 in a manner described more completely below. A human viewer perceives a three-dimensional image when each eye of the viewer sees a different view of the image corresponding to different respective angles of view. Three-dimensional viewing devices with special features that limit perception of a single view to a single eye can show three-dimensional images with just two views. Autostereoscopic displays of three-dimensional images can require many more views.

FIG. 2 shows a left view 104L and a right view 104R of image 104 to illustrate the creation of multiple views of an image for three-dimensional effect. Left view 104L is intended to be viewed by the viewer's left eye, which is naturally positioned to the left of the viewer's right eye. Accordingly and in a manner described more completely below, to simulate a view of image 104 from a position to the left of the camera's lens, elements of image 104 that are nearer to camera 102 are shifted to the right in left view 104L. Elements of image 104 further from camera 102 are shifted to the left. The amount each element is shifted is proportional to the distance from a base distance from camera 102 at which elements are not shifted at all.

Camera 102 creates right view 104R in the same manner but with the direction of shifting of elements reversed. In other words, elements of image 104 that are nearer to camera 102 are shifted to the left in right view 104R and elements of image 104 further from camera 102 are shifted to the right. This shifting can be seen in left view 104L and right view 104R in the alignment of the top of the head of the woman in the foreground with the line of trees in the distant background relative to the alignment of those elements in image 104.

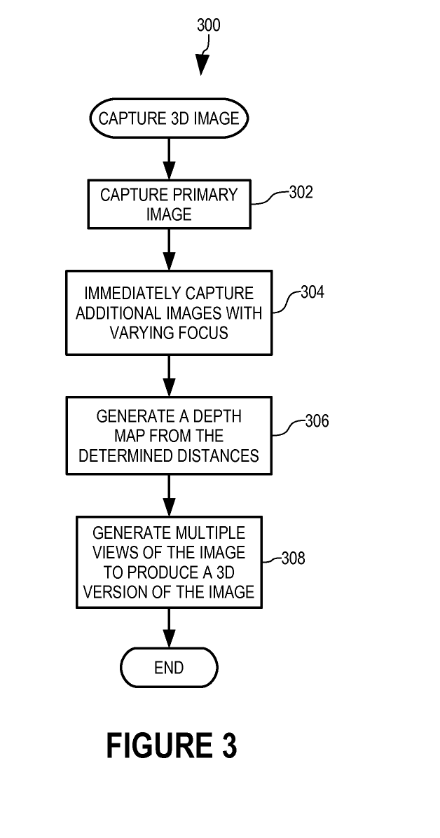

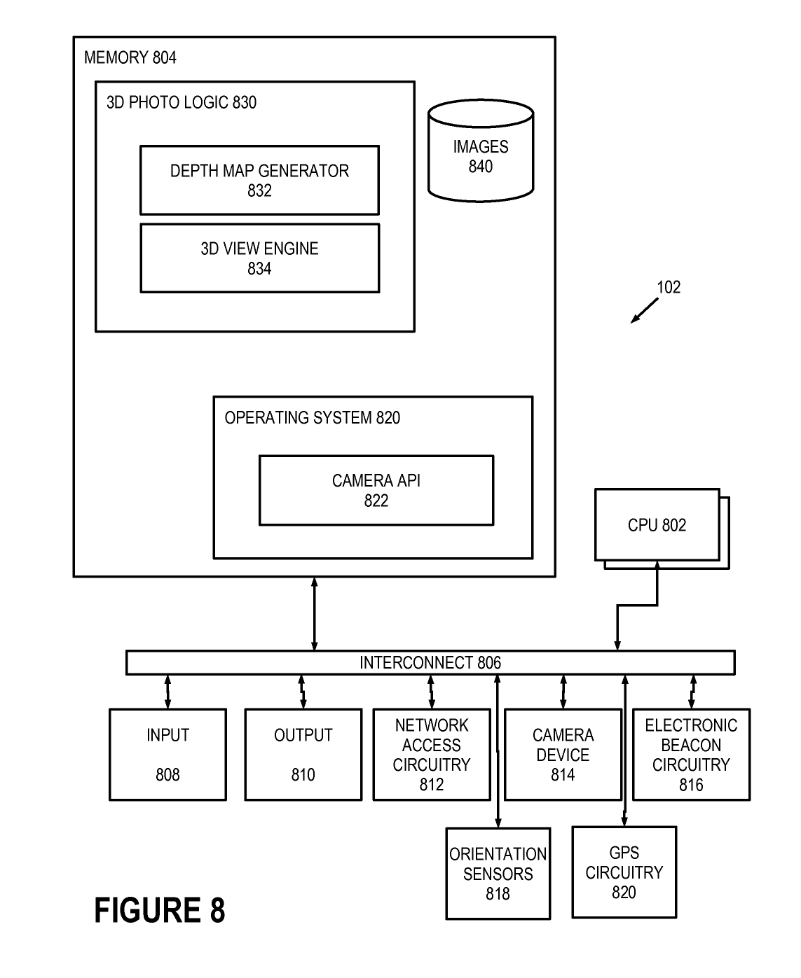

The manner in which camera 102 generates three-dimensional images using a two-dimensional camera is illustrated by logic flow diagram 300 (FIG. 3). As described more completely below, camera 102 includes 3D photo logic 830 (FIG. 8) that interacts with a camera API 822 of an operating system 820 to control a camera device 814 of camera 102. Processing according to logic flow diagram 300 (FIG. 3) begins when a user of camera 102 aims camera 102 at image 104 and presses an input device 808, such as a button, to cause camera 102 to capture image 104.

In step 302, 3D photo logic 830 captures image 104 as a primary image through camera device 808.

In step 304, 3D photo logic 830 captures additional versions of image 104 as quickly as possible with varying focus settings. Reducing time between capture of image 104 and these additional versions thereof reduces the likelihood that the objects being photographed will have moved significantly or that camera 102 itself will have moved significantly, producing better results.

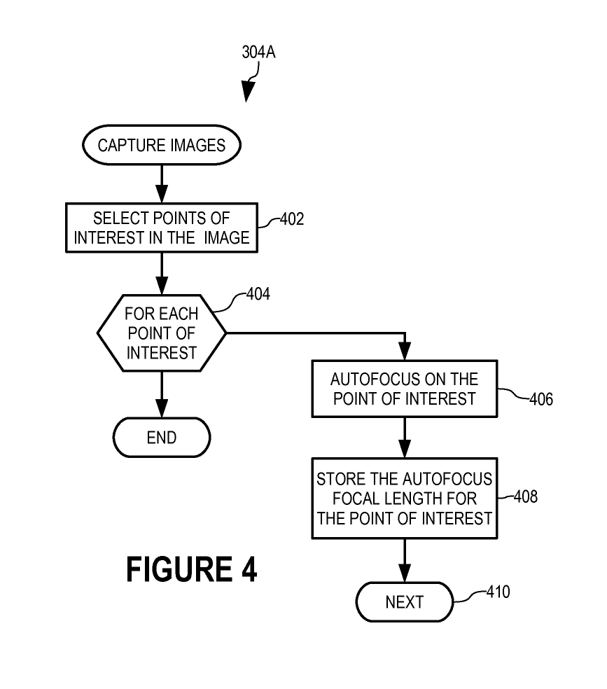

One embodiment of step 304 is shown in greater detail as logic flow diagram 304A (FIG. 4). In step 402, 3D photo logic 830 selects points of interest in image 104. In one embodiment, the points of interest are predetermined locations within image 104 distributed throughout image 104 with a density believed to be sufficient to provide adequate distance information to generate multiple views from image 104. In an alternative embodiment, 3D photo logic 830 analyses image 104 to parse image 104 into subject matter regions and places at least one point of interest within each subject matter region.

Referring to image 104 (FIG. 1), 3D photo logic 830 uses conventional image processing tools such as edge detection, color matching, pattern recognition, etc. to parse image 104 into subject matter regions. For example, 3D photo logic 830 detects a dark region—relative to its surroundings—in the lower left portion of image 104 and uses edge detection, color matching, and pattern recognition to map a boundary between the dark subject matter region corresponding to the dog and the lighter subject matter region corresponding to the grass around the dog. Once 3D photo logic 830 has identified and mapped all subject matter regions of image 104, 3D photo logic 830 includes at least one point of interest within each subject matter region in step 402 (FIG. 4). 3D photo logic 830 includes more points of interest in larger subject matter regions, e.g., the grass background of image 104.

Camera APIs such as camera API 822 recognize faces and set recognized faces as points of interest for autofocus. 3D photo logic 830 can include those in the points of interest selected in step 402.

Loop step 404 and next step 410 define a loop in which 3D photo logic 830 processes each of the points of interest selected in step 402 according to steps 406-408. During each iteration of the loop of steps 404-410, the particular point of interest processed by 3D photo logic 830 is sometimes referred to as the subject point of interest.

In step 406, 3D photo logic 830 causes camera API 822 to autofocus on the subject point of interest. In step 408, 3D photo logic 830 receives from camera API 822 and stores the focal length resulting from the autofocus of step 406. Depending on the particular configuration camera API 822, 3D photo logic 830 might have to cause camera API 822 to capture an image to engage the autofocus feature and/or to ascertain the resulting focal length.

Processing by 3D photo logic 830 transfers from step 408 through next step 410 to loop step 404 in which the next point of interest is processed according to the loop of steps 404-410. When all points of interest have been processed by 3D photo logic 830 according to the loop of steps 404-410, processing according to logic flow diagram 304A—and therefore step 304—completes.

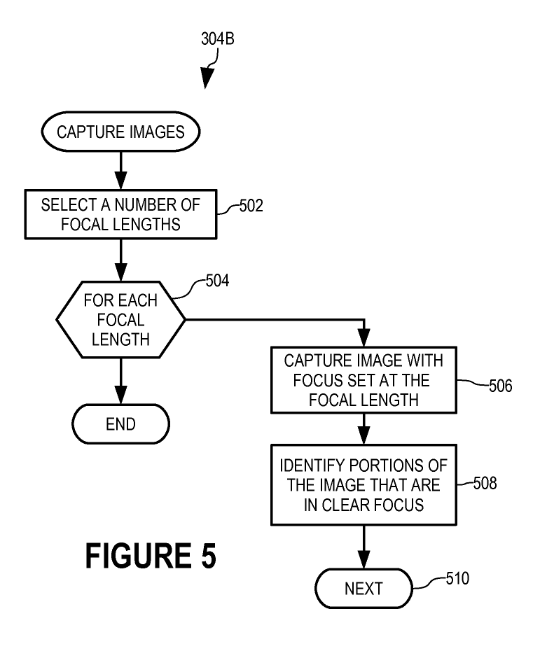

An alternative embodiment of step 304 (FIG. 3) is shown as logic flow diagram 304B (FIG. 5). In step 502, 3D photo logic 830 selects a number of focal lengths. In this illustrative embodiment, 3D photo logic 830 selects focal lengths distributed throughout the range of focal lengths of which camera device 814 is capable. Depth measurement accuracy is improved when using more focal lengths. However, it is preferred that all focal lengths be processed within a limited amount of time so that objects in the field of view of camera 102 don't move significantly during processing of the focal lengths. Accordingly, a camera that is relatively slow in refocusing and capturing an additional image will have fewer focal lengths and will have compromised accuracy in measured distances.

Loop step 504 and next step 510 define a loop in which 3D photo logic 830 processes each of the focal lengths selected in step 502 according to steps 506-508. During each iteration of the loop of steps 504-510, the particular focal length processed by 3D photo logic 830 is sometimes referred to as the subject focal length.

In step 506, 3D photo logic 830 causes camera API 822 to capture an image with focus of camera device 814 set at the subject focal length. In step 508, 3D photo logic 830 performs edge detection analysis on the image captured in step 506 to identify portions of the captured image that are in clear focus at the subject focal length.

Processing by 3D photo logic 830 transfers from step 508 through next step 510 to loop step 504 in which the next focal length is processed according to the loop of steps 504-510. When all focal lengths have been processed by 3D photo logic 830 according to the loop of steps 504-510, processing according to logic flow diagram 304B—and therefore step 304 (FIG. 3)—completes.

Thus, after step 304, 3D photo logic 830 has determined estimate distances from camera 102 to a number of elements of image 104. At this point, all information from which a 3D version of image 104 will be produced has been gathered. 3D photo logic 830 can package this data for export to other computing devices that can produce the 3D version of image 104 or can processed by 3D photo logic 830 to produce the 3D version of image 104.

For export, 3D photo logic 830 can represent all estimated distance information as a depth map in an alpha channel of data representing image 104. For example, if the alpha channel has depth of 8 bits, the estimated depths can be normalized to have a range of 0, representing the minimal focal length of camera 102, to 255, representing the maximum focal length of camera 102. Exif (Exchangeable image file format) meta-data in the stored image can specify the range of distances represented in the alpha channel. An example of a depth map is shown as depth map 1400 (FIG. 14).

In embodiments in which 3D photo logic 830 exports image 104 and the estimated distance information, steps 306 and 308 are performed by a different computing device to produce the 3D version of image 104. In this illustrative embodiment, steps 306-308 are performed by 3D photo logic 830.

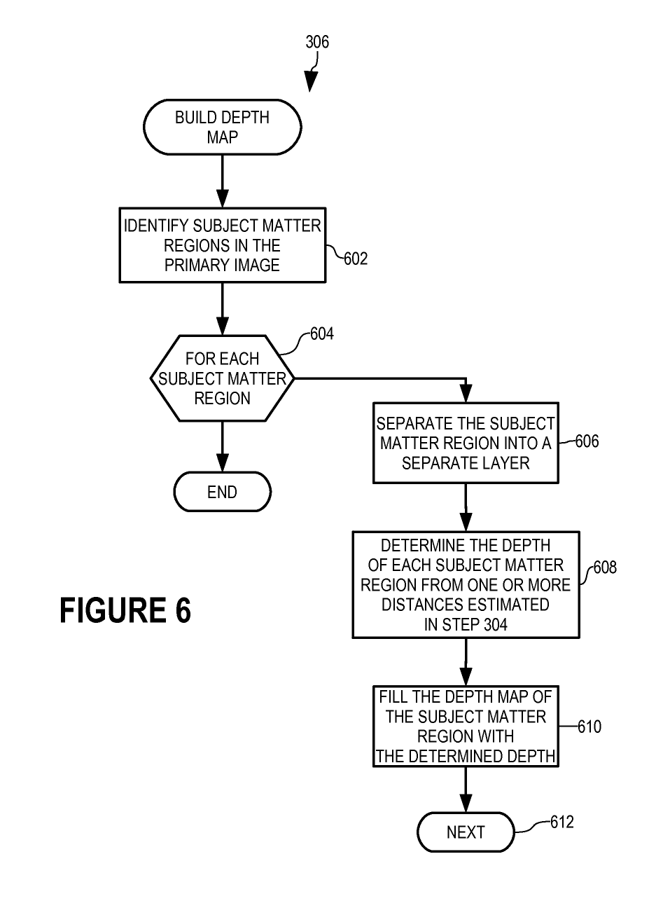

In step 306, a depth map generator 832 (FIG. 8) of 3D photo logic 830 determines depths at which all elements shown in image 104 will appear in the 3D version of image 104. These depths are derived from estimated distances from camera 102 of the elements of image 104. In step 304 (FIG. 3), distances were estimated for only a few points within image 104. In step 306, depth map generator 832 uses those estimated distances to fill in depth information for the entirety of image 104. Step 306 is shown in greater detail as logic flow diagram 306 (FIG. 6).

In step 602, depth map generator 832 identifies subject matter regions in image 104 in the manner described above with respect to step 402, unless step 402 has already been performed and subject matter regions in image 104 have already been identified. Even if such subject matter regions have been identified previously, depth map generator 832 can ensure that they were properly identified by identifying outlier distance estimations. For example, if a single subject matter region includes several distance estimates of about 3 meters and one or two distance estimates of 15 meters, depth map generator 832 determines that the previously identified subject matter region likely include two separate subject matter regions. In such circumstances, depth map generator 832 re-evaluates image 104 in light of the distance estimates to provide a more accurate identification of subject matter regions of image 104.

Loop step 604 and next step 612 define a loop in which depth map generator 832 processes each of the subject matter regions identified in step 602 according to steps 606-610. During each iteration of the loop of steps 604-612, the particular subject matter region (SMR) processed by depth map generator 832 is sometimes referred to as the subject SMR.

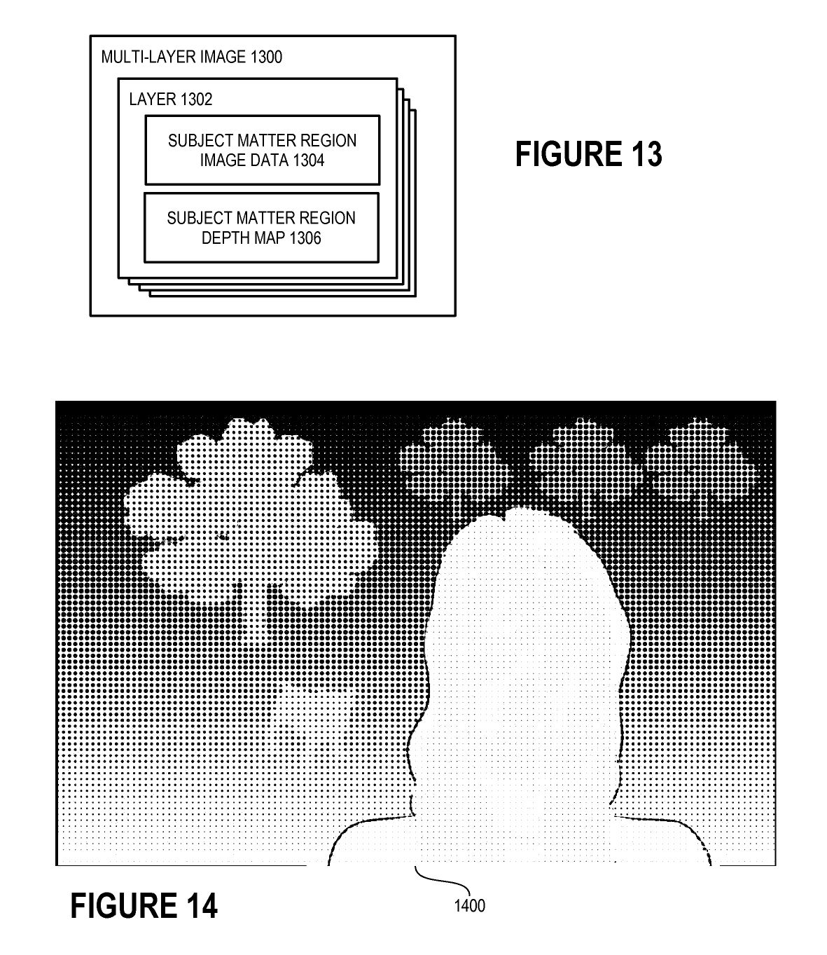

In step 606, depth map generator 832 separates the subject SMR into a separate layer of an image. The structure of the multi-layer depth map created by depth map generator 832 in this illustrative embodiment is illustrated by multi-layer image 1300 (FIG. 13). Multi-layer image 1300 includes a number of layers 1302, each of which represents a subject matter region. Each layer 1302 includes subject matter region image data 1304 and a subject matter region depth map 1306. The layer 1302 created by depth map generator 832 in step 606 (FIG. 6) includes the portion of image 104 corresponding to the subject SMR in isolation, i.e., with the portions of the subject matter region image data 1304 corresponding to all other subject matter regions being 100% transparent.

In step 608, depth map generator 832 converts focal lengths gathered in step 304 to estimated distances from camera 102 and converts the estimate distances to depths. In the embodiment shown in logic flow diagram 304A (FIG. 4), repeated use of autofocus for each of a number of points of interest provides information regarding the relatively optimal focal length for that point of interest. In the embodiment shown in logic flow diagram 304B (FIG. 5), repeated image capture and analysis for each of a number of focal lengths provides information regarding the portions of subject matter within image 104 that are in good focus for that focal length. In either case, depth map generator 832 converts those focal lengths to estimated distances from camera 102 and therefrom into depths in step 608 (FIG. 6).

In step 610, depth map generator 832 fills subject matter region depth map 1306 of the subject SMR with depth information gathered in step 608. In this illustrative embodiment, subject matter region depth map 1306 is coextensive with subject matter region image data 1304 in that no depth information is included in subject matter region depth map 1306 for areas of subject matter region image data 1304 that are transparent. In step 608, depth information is estimated from focal lengths gathered in step 304 (FIG. 3) for just a sampling of points within image 104. For example, just a few points within a subject matter region corresponding to the woman in the foreground of image 104 might be available. In step 610 (FIG. 6), depth map generator 832 fills the entire subject matter region layer with depth information derived from those few points.

In one embodiment, depth map generator 832 calculates an average depth for all points within the subject SMR and fills subject matter region depth map 1306 with the average of the estimated depths. In an alternative embodiment, depth map generator 832 makes the assumption that points within a subject matter region at a given distance from the edge of the subject matter region are at similar distances from camera 102. For example, if a person's ear is estimated to be at a given distance from camera 102 and the person's nose is estimated to be at a slightly shorter distance from camera 102, points in the subject matter region representing the person nearer the edge of the subject matter region are estimated to have the estimated depth of the ear and points near the center of the subject matter region are estimated to have the estimated depth of the nose. Points at other distances from the edge of the subject matter region are interpolated according to such distances.

Image 104 is shown to have a grass background (shown as a plain white background). While the background can be considered to be entirely represented by a single subject matter region, estimated distances for the grass background will vary widely. There are a number of ways of properly filling the grass background with distance information derived from the points of depth estimated in step 608 from focal lengths gathered in step 304.

In one embodiment, depth map generator 832 limits subject matter regions to a predetermined maximum height. For example, the predetermined height can be one-tenth of the vertical resolution of image 104. Thus, no average estimated distance can apply to the entirety of the grass background but instead for at most a one-tenth section of the grass background sliced horizontally.

In an alternative embodiment, depth map generator 832 assumes that portions of a background subject matter region of a common elevation within image 104 have similar estimated distances from camera 102. Depth map generator 832 distinguishes background subject matter regions from other subject matter regions in that background subject matter regions (i) border many other subject matter regions, even encircling some, and (ii) border the edges of image 104 more than other subject matter regions.

In this alternative embodiment, depth map generator 832 assigns estimated depths according to elevation of points within the background subject matter regions. To fill in estimated depths at elevations for which no depths were estimated in step 604 from focal lengths gathered in step 304, depth map generator 832 interpolates between elevations for which depths were estimated, and extrapolates from such elevations to the borders of image 104.

It should be noted that elevation refers to true elevation and not a vertical coordinate within image 104. Modern smart phones include orientation sensors 818 (FIG. 8) such that any tilt of camera 102 at the time image 104 is captured can be determined. Depth map generator 832 uses data from these orientation sensors to determine truly horizontal lines of reference within image 104 to provide true elevation information regarding subject matter regions within image 104.

After step 610, processing by depth map generator 832 transfers through next step 612 to loop step 604 and the next subject matter region is processed according to the loop of steps 604-612. When all subject matter regions of image 104 have been processed according to the loop of steps 604-612, processing according to logic flow diagram 306, and therefore step 306 (FIG. 3), completes. Depth map generator 832 ensures that, when step 306 is complete, layers 1302 (FIG. 13) are sorted according to depth such that layers corresponding to subject matter regions nearer to the viewer are above layers corresponding to subject matter regions further from the viewer.

Depth map 1400 (FIG. 14) corresponds to image 104 and illustrates depth maps generally. Portions of image 104 that are nearer the viewer are represented by lighter shades of grey in depth map 1400. Conversely, portions of image 104 that are further from the viewer are represented by darker shades of grey in depth map 1400. While depth map 1400 is shown in half-tone, it should be appreciated that depth maps are typically shown as greyscale images.

Depth map 1400 is accurately representative of a single depth map for the entirety of image 104. Depth map 1400 is also accurately representative of subject matter region depth map 1306 (FIG. 13) for all layers 1302 viewed concurrently. For example, the portion of depth map 1400 containing depth information for the dog in the near background is visible because the layer representing the woman in the foreground is transparent everywhere except where the woman is shown.

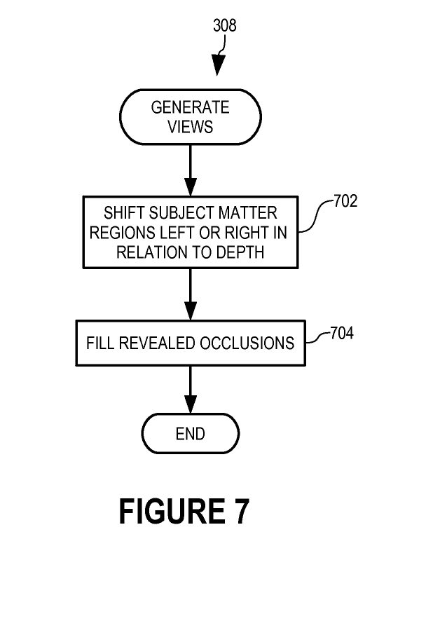

In step 308, a 3D view engine 834 (FIG. 8) of 3D photo logic 830 generates multiple views of image 104 from various horizontal offsets to produce a 3D version of image 104. Step 308 (FIG. 3) is shown in greater detail as logic flow diagram 308 (FIG. 7).

In step 702, 3D view engine 834 shifts subject matter regions of image 104 horizontally by an amount proportional to a depth of each subject matter region from a base depth, which corresponds to a depth origin in the three-dimensional coordinate space of a display. The horizontal shifting to produce multiple views of image 104 is described above with respect to views 104L (FIG. 2) and 104R. In addition, storing each subject matter region as a separate layer 1302 (FIG. 13) in multi-layer image 1300 facilitates easy, independent shifting of individual subject matter regions.

In step 704, 3D view engine 834 fills any revealed occlusions. Occlusion reveal is an artifact of generating synthetic views in the manner described with respect to step 702. It is helpful to consider the example of view 104L (FIG. 2). To produce view 104L from image 104 (FIG. 1), the woman in the foreground is shifted to the right and the trees in the distant background are shifted to the left. Doing so reveals a portion of the grass background and a portion of the trees in the distant background that are not visible in image 104. Since those portions are not visible in image 104, there is no image data from which those revealed occlusions can be filled.

3D view engine 834 uses a number of techniques to fill revealed occlusions. 3D view engine 834 used pattern recognition techniques to identify patterns in a subject matter region near a revealed occlusion. For example, 3D view engine 834 can recognize grass as a repeating pattern and repeat that pattern to fill a revealed occlusion in the grass background of image 104.

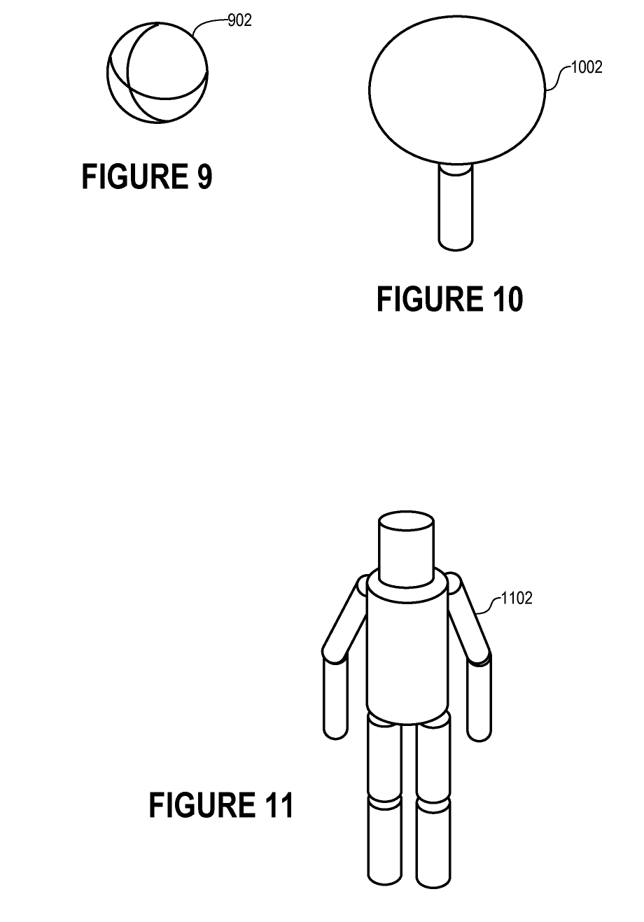

3D view engine 834 also uses a number of predetermined shape primitives to recognize types of objects in image 104 and uses a number of predetermined features of such objects to fill revealed occlusions that include those objects. FIGS. 9-11 show a few illustrative examples of shape primitives used by 3D view engine 834.

Primitive 902 (FIG. 9) is a sphere. When 3D view engine 834 recognizes subject matter in image 104 that appears to be a sphere, 3D view engine 834 uses the portion of image 104 representing the recognized sphere to derive a graphical skin of the sphere and uses patterns in the graphical skin to draw portions of the sphere needed to fill revealed occlusions.

It is helpful to consider the example of a soccer ball. The center of the soccer ball appears to have nearly regular pentagons and hexagons because the viewing angle to that portion of the soccer ball is nearly perpendicular. However, the surface pattern near the edge of the soccer ball is viewed from much sharper angles. Merely recognizing the surface pattern and replicating the pattern of the soccer ball surface in revealed occlusions gives the soccer ball an artificially flat appearance. However, by recognizing the soccer ball as a sphere and mapping the derived graphical skin to the sphere, the proper spherical appearance of the soccer ball is maintained in filled-in portions of the revealed occlusions.

Primitive 1002 (FIG. 10) represents a tree as an ellipsoid over a cylinder and is associated with an assumption that trees with similar appearances and of similar size have similar heights. Image 104 (FIG. 1) includes three (3) trees in the distant background. The trunk in the tree in the center is occluded by the head of the woman in the foreground. In this illustrative example, 3D view engine 834 fills in at least a portion of that trunk in producing views 104L (FIGS. 2) and 104R.

3D view engine 834 recognizes that all three (3) trees in the distant background are approximately the same size and distance from camera 102 and therefore estimates a size and length of the trunk of the center tree. 3D view engine 834 gathers image data to fill in the trunk in the revealed occlusion from other trees in the same general location with a similar appearance or by repeating any recognized patterns in the portion of the center tree's trunk that are visible in image 104.

Primitive 1102 (FIG. 11) represents a human being as a collection of ten (10) interconnected cylinders as shown and is associated with a number of assumptions. One of these assumptions is that human beings appear symmetrical across a vertical axis. For example, a person's right ear is assumed to be a mirror (i.e., horizontally flipped) image of the person's left ear. While people are not so symmetrical in appearance in reality, this assumption is close enough to the truth that image data from one side of a person can be used to fill revealed occlusions in the person's other side with relatively good results.

3D view engine 834 also uses other images of the same subject matter for acquiring image data to fill in revealed occlusions. In particular, 3D view engine 834 identifies one or more images other than image 104 that can include the same subject matter. Camera 102 stores Exif meta data for all captured images, including a time stamp, geographical location data, and three-dimensional camera orientation data. Accordingly, 3D view engine 834 can identify all images captured by camera 102 that are captured at about the same time as image 104, from about the same place as image 104, and at about the same viewing angle as image 104.

Once such images are identified, 3D view engine 834 looks for image data in such similar images that matches closely to image data near revealed occlusions in the various synthesized views of image 104 and uses image data from those similar images to fill such revealed occlusions.

In this illustrative embodiment, 3D photo logic 830 stores images captured in step 304 (FIG. 3), e.g., in step 406 (FIG. 4) in which an additional image is captured with each application of autofocus or in step 506 (FIG. 5) and, for each such image, produces a multi-layer depth map in the form of multi-layer image 1300 (FIG. 13). These captured images can also provide image data to fill in revealed occlusions as each image can differ slightly.

Capturing multiple images in step 304 in this manner provides an additional benefit. Each of the images will have better focus in different areas. For example, in one of these images, the woman in the foreground of image 104 will be in focus while the dog in the near background might be slightly out of focus. However, in estimating the distance of the dog from camera 102, an image in which the dog is in particularly good focus is collected. In composing multiple views in step 308, 3D photo logic 830 can use subject matter region image data 1304 from the particular image that includes that subject matter region most in focus.

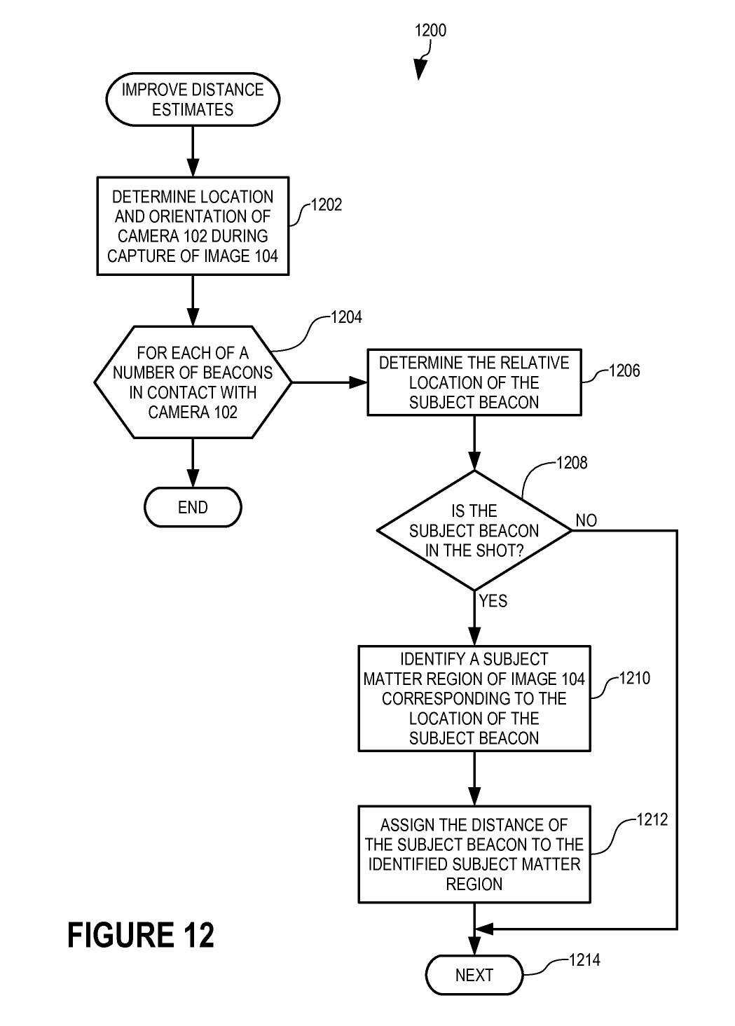

As described above with respect to step 306 (FIG. 3), 3D photo logic 830 determines distances of respective elements in image 104 from camera 102. 3D photo logic 830 can use relative locations of electronic beacons to improve the accuracy of such distance determinations in a manner illustrated by logic flow diagram 1200 (FIG. 12).

In step 1202, 3D photo logic 830 determines the location and orientation of camera 102 contemporaneously with capture of image 104 in step 302 (FIG. 3). Like many mobile telephones available today, camera 102 includes GPS circuitry 820 (FIG. 8) to determine the location of camera 102 and orientation sensors 818 to determine the orientation of camera 102. Accordingly, 3D photo logic 830 is able to determine, with relative accuracy, the direction in which camera 102 is pointed during capture of image 104 and therefore an area that is visible to camera device 814.

Loop step 1204 and next step 1214 define a loop in which 3D photo logic 830 processes each of a number of electronic beacons that are in communication with camera 102 according to steps 1206-1212. Electronic beacons are known and only briefly described herein for completeness. An example of an electronic beacon is the iBeacon available from Apple Inc. of Cupertino, Calif. Such beacons are used for precise, localized determination of the location of a device, such as camera 102 for example. Camera 102 includes electronic beacon circuitry 816 (FIG. 8) for communication with such electronic beacons. Devices, such as camera 102, that can communicate with electronic beacons can also communicate with one another. During each iteration of the loop of steps 1204-1214, the particular beacon processed according to steps 1206-1212 is sometimes referred to as the subject beacon in the context of logic flow diagram 1200.

In step 1206, 3D photo logic 830 determines the location of the subject beacon relative to camera 102. 3D photo logic 830 determines the bearing from camera 102 to the subject beacon, the distance of the subject beacon from camera 102, and the relative elevation of the subject beacon from camera 102.

There are a number of ways in which 3D photo logic 830 makes these determinations. In one embodiment, electronic beacons are capable of determining their own positions—using GPS circuitry for example—and report their positions to camera 102 when queried. In another embodiment, 3D photo logic 830 estimates distances to each electronic beacon using the relative strength of the electronic beacon signal received. Multiple distances estimates made over time from different positions allow 3D photo logic 830 to triangulate locations of each electronic beacon.

In test step 1208, 3D photo logic 830 determines whether the subject beacon is likely to be in the frame of image 104 by comparing the relative location of the subject beacon determined in step 1206 to the area that is visible to camera device 814 during capture of image 104. If the subject beacon is not likely to be in the frame of image 104, processing by 3D photo logic 830 transfers through next step 1214 to loop step 1204 and the next beacon is processed according to the loop of steps 1204-1214.

Conversely, if the subject beacon is likely to be in the frame of image 104, processing by 3D photo logic 830 transfers to step 1210 in which 3D photo logic 830 identifies a subject matter region of image 104 that corresponds to the location of the subject beacon. In one embodiment, 3D photo logic 830 identifies this subject matter region by identifying a subject matter region of image 104 that is at or near the location and distance within predetermined tolerances.

In an alternative embodiment, 3D photo logic 830 uses a graphical user interface to ask the user to locate the beacon within image 104. Communications with the subject beacon provides data identifying the type of beacon, including the type of device in which the beacon is installed. Accordingly, 3D photo logic 830 can prompt the user of camera 102 to touch a touch-sensitive screen of camera 102 displaying image 104 at a location at which a particular type of device is believed to be located. For example, 3D photo logic 830 can prompt the user to “please touch the screen where an Apple iPad is believed to be.”

In another alternative embodiment, 3D photo logic 830 can combine these two embodiments, either prompting the user to confirm an automatically detected location of the subject beacon in image 104 or only prompting the user to locate the subject beacon upon failure to automatically detect the location of the subject beacon in image 104.

In step 1212, 3D photo logic 830 assigns the distance of the subject beacon determined in step 1206 to the subject matter region identified in step 1210. After step 1212, processing by 3D photo logic 830 transfers through next step 1214 to loop step 1204 and the next beacon in contact with camera 102 is processed by 3D photo logic 830 according to the loop of steps 1204-1214. When all beacons in contact with camera 102 have been processed according to the loop of steps 1204-1214, processing according to logic flow diagram 1200 completes.

Some elements of camera 102 are shown diagrammatically in FIG. 8. Camera 102 is a smart phone in this illustrative embodiment. However, many other types of devices include both the ability to capture images and the image processing capabilities described herein, and camera 102 can be any of these devices as well. Camera 102 includes one or more microprocessors 802 (collectively referred to as CPU 802) that retrieve data and/or instructions from memory 804 and execute retrieved instructions in a conventional manner. Memory 804 can include any tangible computer readable media, e.g., persistent memory such as magnetic and/or optical disks, ROM, and PROM and volatile memory such as RAM.

CPU 802 and memory 804 are connected to one another through a conventional interconnect 806, which is a bus in this illustrative embodiment and which connects CPU 802 and memory 804 to one or more input devices 808 and/or output devices 810, network access circuitry 812, camera device 814, and electronic beacon circuitry 816. Input devices 808 can include, for example, a keyboard, a keypad, a touch-sensitive screen, a mouse, and a microphone. Output devices 810 can include a display—such as a liquid crystal display (LCD)—and one or more loudspeakers. Network access circuitry 812 sends and receives data through computer networks.

Camera device 814 includes circuitry and optical elements that are collectively capable of capturing images of an environment in which camera 102 is located. Electronic beacon circuitry 816 includes circuitry that establishes communication with external electronic beacons and determines respective locations of the external electronic beacons relative to camera 102. Orientation sensors 818 measure orientation of camera 102 in three dimensions and report measured orientation through interconnect 806 to CPU 802. GPS circuitry 820 cooperates with a number of geographical positioning satellites to determine a location of camera 102 in three dimensions in a conventional manner and reports determined location through interconnect 806 to CPU 802. Devices 808-820 are conventional and known and are not described further herein.

A number of components of camera 102 are stored in memory 804. In particular, 3D photo logic 830 and operating system 820 are each all or part of one or more computer processes executing within CPU 802 from memory 804 in this illustrative embodiment but can also be implemented, in whole or in part, using digital logic circuitry. As used herein, “logic” refers to (i) logic implemented as computer instructions and/or data within one or more computer processes and/or (ii) logic implemented in electronic circuitry. Images 840 is data representing one or more images captured by camera 102 and stored in memory 804.

Operating system 820 is the operating system of camera 102. An operating system (OS) is a set of logic that manages computer hardware resources and provides common services for application software such as 3D photo logic 830. Operating system 820 includes a camera Application Programming Interface (API) 822, which is that part of operating system 820 that allows logic within camera 102, e.g., 3D photo logic 830, to access and control camera device 814.

3D photo logic 830 includes a depth map generator 832 and a 3D view engine 834 that cooperate in the manner described above to produce three-dimensional images from an image captured through a conventional two-dimensional camera device 814.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for producing a three-dimensional image using a single-lens camera, the method comprising:
capturing a source image using the camera;
adjusting a focus state of the camera while the camera continues to point at the subject matter of the source image to determine respective distances of one or more elements of the subject matter of the source image from the camera; and
generating two or more views of the source image to produce the three-dimensional image by, for each of the views:
determining a viewing perspective of the view; and
shifting each of the elements of the subject matter of the source image along a horizontal plane in relation to the respective distance of the element from the camera.

2. The method of claim 1 wherein adjusting the focus state of the camera comprises:
selecting two or more points of interest in an area viewable to the camera; and
for each of the points of interest:
initiating an autofocus function of the camera at the point of interest to cause the camera to select a focal length for the point of interest; and
using the selected focal length to estimate a distance for the point of interest.

3. The method of claim 1 wherein adjusting the focus state of the camera comprises:
selecting two or more focal lengths; and
for each of the focal lengths:
causing the camera to capture an image through a lens adjusted to the focal length; and
identifying area of sharp focus in the image to identify areas at a distance corresponding to the focal length.

4. The method of claim 1 further comprising, for each of the views:
representing each of the elements in a separate layer.

5. The method of claim 1 further comprising, for each of the views:
identifying at least one revealed occlusion resulting from the shifting of each of the elements.

6. The method of claim 5 further comprising, for each of the views:
filling the revealed occlusion with image data from one or more additional images other than the source image.

7. The method of claim 5 further comprising, for each of the views:
determining that the revealed occlusion corresponds to an element of the source image that matches one of a number of predetermined object primitives; and
filling the revealed occlusion with image data generated from the element and the matched object primitive.

8. The method of claim 1 further comprising:
determining the respective locations of one or more beacons in relation to the camera;
identifying a selected one of the one or more elements of the source image that is co-located with at least an in-view one of the beacons; and
estimating the respective distance of the selected element from the camera in accordance with the respective location of the in-view beacon.

9. A tangible computer readable medium useful in association with a computer which includes one or more processors and a memory, the computer readable medium including computer instructions which are configured to cause the computer, by execution of the computer instructions in the one or more processors from the memory, to produce a three-dimensional image using a single-lens camera, by at least:
capturing a source image using the camera;
adjusting a focus state of the camera while the camera continues to point at the subject matter of the source image to determine respective distances of one or more elements of the subject matter of the source image from the camera; and
generating two or more views of the source image to produce the three-dimensional image by, for each of the views:
determining a viewing perspective of the view; and
shifting each of the elements of the subject matter of the source image along a horizontal plane in relation to the respective distance of the element from the camera.

10. The computer readable medium of claim 9 wherein adjusting the focus state of the camera comprises:
selecting two or more points of interest in an area viewable to the camera; and
for each of the points of interest:
initiating an autofocus function of the camera at the point of interest to cause the camera to select a focal length for the point of interest; and
using the selected focal length to estimate a distance for the point of interest.

11. The computer readable medium of claim 9 wherein adjusting the focus state of the camera comprises:
selecting two or more focal lengths; and
for each of the focal lengths:
causing the camera to capture an image through a lens adjusted to the focal length; and
identifying area of sharp focus in the image to identify areas at a distance corresponding to the focal length.

12. The computer readable medium of claim 9 wherein the computer instructions are configured to cause the computer to produce a three-dimensional image using a single-lens camera, by at least also, for each of the views:
representing each of the elements in a separate layer.

13. The computer readable medium of claim 9 wherein the computer instructions are configured to cause the computer to produce a three-dimensional image using a single-lens camera, by at least also, for each of the views:
identifying at least one revealed occlusion resulting from the shifting of each of the elements.

14. The computer readable medium of claim 13 wherein the computer instructions are configured to cause the computer to produce a three-dimensional image using a single-lens camera, by at least also, for each of the views:
filling the revealed occlusion with image data from one or more additional images other than the source image.

15. The computer readable medium of claim 13 wherein the computer instructions are configured to cause the computer to produce a three-dimensional image using a single-lens camera, by at least also, for each of the views:
determining that the revealed occlusion corresponds to an element of the source image that matches one of a number of predetermined object primitives; and
filling the revealed occlusion with image data generated from the element and the matched object primitive.

16. The computer readable medium of claim 9 wherein the computer instructions are configured to cause the computer to produce a three-dimensional image using a single-lens camera, by at least also:
determining the respective locations of one or more beacons in relation to the camera;
identifying a selected one of the one or more elements of the source image that is co-located with at least an in-view one of the beacons; and
estimating the respective distance of the selected element from the camera in accordance with the respective location of the in-view beacon.

17. A computer system comprising:
at least one processor;
a computer readable medium operatively coupled to the processor; and
three-dimensional photo logic (i) that at least in part executes in the processor from the computer readable medium and (ii) that, when executed by the processor, causes the computer to produce a three-dimensional image using a single-lens camera by at least:
capturing a source image using the camera;
adjusting a focus state of the camera while the camera continues to point at the subject matter of the source image to determine respective distances of one or more elements of the subject matter of the source image from the camera; and
generating two or more views of the source image to produce the three-dimensional image by, for each of the views:
determining a viewing perspective of the view; and
shifting each of the elements of the subject matter of the source image along a horizontal plane in relation to the respective distance of the element from the camera.

18. The computer system of claim 17 wherein adjusting the focus state of the camera comprises:
selecting two or more points of interest in an area viewable to the camera; and
for each of the points of interest:
initiating an autofocus function of the camera at the point of interest to cause the camera to select a focal length for the point of interest; and
using the selected focal length to estimate a distance for the point of interest.

19. The computer system of claim 17 wherein adjusting the focus state of the camera comprises:
selecting two or more focal lengths; and
for each of the focal lengths:
causing the camera to capture an image through a lens adjusted to the focal length; and
identifying area of sharp focus in the image to identify areas at a distance corresponding to the focal length.

20. The computer system of claim 17 wherein the computer instructions are configured to cause the computer to produce a three-dimensional image using a single-lens camera, by at least also, for each of the views:
representing each of the elements in a separate layer.

21. The computer system of claim 17 wherein the three-dimensional photo logic causes the computer to produce a three-dimensional image using a single-lens camera, by at least also, for each of the views:
identifying at least one revealed occlusion resulting from the shifting of each of the elements.

22. The computer system of claim 21 three-dimensional photo logic causes the computer to produce a three-dimensional image using a single-lens camera, by at least also, for each of the views:
filling the revealed occlusion with image data from one or more additional images other than the source image.

23. The computer system of claim 21 wherein the three-dimensional photo logic causes the computer to produce a three-dimensional image using a single-lens camera, by at least also, for each of the views:
determining that the revealed occlusion corresponds to an element of the source image that matches one of a number of predetermined object primitives; and
filling the revealed occlusion with image data generated from the element and the matched object primitive.

24. The computer system of claim 17 wherein the three-dimensional photo logic causes the computer to produce a three-dimensional image using a single-lens camera, by at least also:
determining the respective locations of one or more beacons in relation to the camera;
identifying a selected one of the one or more elements of the source image that is co-located with at least an in-view one of the beacons; and
estimating the respective distance of the selected element from the camera in accordance with the respective location of the in-view beacon.
